(19) United States
(12) Patent Application Publication
(10) Pub. No.: US 2009/0132088 A1
(43) Pub. Date: May 21, 2009

(54) TRANSFER OF KNOWLEDGE FROM A HUMAN SKILLED WORKER TO AN EXPERT MACHINE - THE LEARNING PROCESS

(75) Inventor: Isaac Taitler, Haifa (IL)

Correspondence Address: Isaac Taitler, Ramat Almogy, P.O. Box 7404, Haifa, 31073, IL

(73) Assignee: TAIROB Ltd., Haifa (IL)

(21) Appl. No.: 12/108,585

(22) Filed: Apr. 24, 2008

Related U.S. Application Data
(60) Provisional application No. 60/913,663, filed on Apr. 24, 2007.

(51) Int. Cl. G05B 15/00

(52) U.S. Cl. 700/264

(57) ABSTRACT

A learning environment and method which is a first milestone to an expert machine that implements the master-slave robotic concept. The present invention is of a learning environment and method for teaching the master expert machine by a skilled worker that transfers his professional knowledge to the master expert machine in the form of elementary motions and subdivided tasks. The present invention further provides a stand alone learning environment, where a human wearing one or two innovative gloves equipped with 3D feeling sensors transfers a task performing knowledge to a robot in a different learning process than the Master-Slave learning concept. The 3D force\torque, displacement, velocity\acceleration and joint forces are recorded during the knowledge transfer in the learning environment by a computerized processing unit that prepares the acquired data for mathematical transformations for transmitting commands to the motors of a robot. The objective of the new robotic learning method is a learning process that will pave the way to a robot with a “human-like” tactile sensitivity, to be applied to material handling, or man/machine interaction.

### CROSS REFERENCE TO RELATED APPLICATIONS

This application claims the benefit under 35 USC 119(e) from U.S. provisional application 60/913,663 filed Apr. 24, 2007, the disclosure of which is included herein by reference.

The present invention relates to U.S. Pat. No. 6,272,396, given to Isaac Taitler, the disclosure of which is incorporated herein by reference for all purposes as if entirely set forth herein.

### FIELD OF THE INVENTION

The present invention relates to robotics and, more particularly, to the learning process in a method of applying knowledge from a human operator to a mobile slave expert machine via a master expert machine.

### BACKGROUND OF THE INVENTION AND PRIOR ART

The traditional manufacturing industry has consisted of production workers who must have good hand-eye coordination and dexterity and who could perform a specific function in an assembly line.

Robots are used for performing tasks in the factory at the production lines or a special purpose tasks in the laboratory or the like for full automation of the process. A traditional robotic system consists of:

a) a robot (for example a 6 degrees of freedom);

b) an end effector (gripper) and tooling equipment; and

c) Installation of the robot in the working area.

Installing a robotic system includes the developing of an end effector for the specific task and accessories needed for the automatic activity of the robot, in addition to the task programming of the robot. The robot's operator should be trained for several months, mostly at the robot's manufacturer place. Those facts cause a manual manufacturing of robots and massive integration & installation activity, leading to a very high cost of the robotic system, and explaining the missing mass production of robotic systems. For the same reasons, performing a professional task (only a skilled worker does) via the present equipment (traditional robotic systems) is a very complicated mission due to the complexity of the integration/controlling of the robot in such activity having clear economic consequences.

There exist known expensive robots of multi-tasking ability, with remarkable flexible reprogramming possibilities, for different tasks. Most types share common problems: high costs, operator training, specific coding (custom software), complicated final debug process at factory and high maintenance cost.

Welding and spray coating of cars along the assembly line are the only known activities where robots are dominant in replacing human labor. Reference is made to FIG. 1 (prior art), which illustrates welding robot 20 which is a present state of the art in robotic technology. The shown manipulator 22 tracks a predefined learnt path while an add-on separate device 24 independently performs the welding task.

Many multi-fingered robot hands and palms (e.g.: the UtaWMIT hand by Jacobsen, “Dexterous Anthropomorphic Robot Hand with Tactile Sensor: Gifu Hand II”, Harukisa Kawasaki, Takashu Kurimoto, Tsuneo Kamatsu, Kauzunao Uchiyama, Gifu university, Japan, 7 Oct. 1989; the Anthrobot hand by Kyriakopoulos et. al, “Kinematic analysis and position/force control of the Anthrobotdextrous hand”, IEEE transactions on Systems, Man, and Cybernetics, Vol. 27, Issue 1, pp. 95-104, February 1997) have been developed. The robot hand is driven by actuators which are located in a remote place from the robot hand frame by using some tendon cables. The elasticity of tendon cable causes inaccurate joint angle control and the long wiring of tendon cables may obstruct the robot motion. In this case the hand is connected to the tip of a robot's arm. Moreover, these hands suffer from many problems regarding the product as well as the maintenance due to its mechanical complexity. To solve these problems, robot hands in which actuators are built in the hand itself (e.g.: Omni hand by Rosheim NASA contracts NAS8-37638 and NAS8-38417 for NASA; NTU hand by Lin et. al., Integrating fuzzy control of the dexterous National Taiwan University (NTU) hand Li-Ren Lin; Han-Pang Huang Mechatronics, IEEE/ASME Transactions on Volume 1, Issue 3, September 1996 Page(s): 216-229; and DLR's hand by Liu et. al., German Aerospace Center Institute of Robotics and Mechatronics Robotic systems based on the DLR-Hand II, DLR and HIT (Harbin Institute of Technology), 8, 2006) have been developed. However, these hands suffer from other problems such as the movement of the robot hand is limited and cannot perform precisely and accurately like human hand tasks. During the last years, servomotors, force sensors at each joint and modern actuators replace the tendon cables. However those so called humanoid or anthropomorphic palms or hands are still very large in size, limited relative to human activity and have no learning capability. No such palm is intended for performing maintenance tasks such as replacing a car's oil filter.

Expensive robots of multi-tasking ability exist, having remarkable flexible reprogramming possibilities. Most tasks (for example, “pick and place”) require only a fraction of these capabilities. However, most existing robots suffer from well known problems: very limited sensitivity regarding to material handling (due to the inconsistency of the material), performance, high costs, operator training, specific coding (custom software), complicated final debug process at factory and high maintenance cost. This organizational philosophy is going to be replaced by an expert machine concept in which goods are made by a group of robotic machines organized into production “modules”. Each expert machine in a module is “trained” to perform nearly all the functions in the assembly line.

FIG. 2 (prior art) illustrates a task of tying laces 27 of shoe 25, a task that is well beyond the capabilities of the present robotic technology.

U.S. Pat. No. 6,272,396 describes a mobile expert machine that moves along a nominal predefined trajectory. The expert machine should be a substitute for unskilled labor performed at workstations characterized by repetitive activities. An expert machine is defined as a machine that performs a specific task; the knowledge applied to the machine should be used to perform a repetitive task professionally. Predefined trajectory is defined as the actual trajectory that the slave expert machine should follow. The slave expert machine should move along a known predefined trajectory whose parameters have been calculated prior to start-up of the motion. It is assumed that the trajectory is given as function of time and the disturbances are well known. A Master Expert Machine (MEM) is incorporated with sensors for sensing and reading joint motions. It features excellent follow-up attributes and records motion activity in its memory by a process of “machine learning” within the study area. A skilled worker transfers his professional knowledge to the master expert machine in the form of elementary motions and subdivided tasks. The required task would be implemented via superposition and concatenation of the elementary moves and subdivided tasks.

The process of transferring knowledge from a skilled worker to an expert machine, is the first segment of the whole concept, includes the following three components that form one unit, according to the learning segment of U.S. Pat. No. 6,272,396.

### BRIEF SUMMARY OF THE INVENTION

It is the intention of the present invention to provide a system and method for teaching the master expert machine (MEM) by a skilled worker that transfers his professional knowledge to the master expert machine in the form of elementary motions and subdivided tasks. The required tasks are implemented via superposition and concatenation of the elementary moves and subdivided tasks. Based on the assumption that every task can be partitioned into a defined set of “elementary trajectories”, the master expert machine is “loaded” by a skilled worker with the required data to implement any elementary trajectory. The term “master-slave robotic concept/system” as used herein refers to the concept/system of applying knowledge from a human operator to a mobile slave expert machine (SEM) via a master expert machine, as describe in U.S. Pat. No. 6,272,396.

According to the present invention there is provided a learning environment for learning task performing knowledge from a human operator, the learning environment including: (a) a cell body defining an restricted learning environment space; (b) one or more 3D feeling sensors; (c) multiple sensors for sensing the presence and motion of an object inside the learning environment space; and (d) a processing unit. The human operator performs the task inside the learning environment space, wherein the 3D feeling sensors provide 3D information regarding contact made by the sensors with a surface of an object or materials. The 3D information is selected from a group including friction, perpendicular force variation, tangential force variation and tactile roughness. In embodiments of the present invention, the 3D feeling sensors are made of piezoelectric materials.

The multiple sensors sense the 3D location, displacement, acceleration and forces of an object inside the learning environment space. The processing unit analyzes and records the data transmitted by the feeling and multiple sensors and by the optical sensors. The multiple sensors are selected from a group including: optical sensors, video cameras, acceleration sensors, RF sensors, sonic sensors and other sensors. One or more of the multiple sensors are video cameras configured to acquire a plurality of images of the environment enclosed in the learning environment.

In embodiments of the present invention, the human operator wears an arrangement or a glove including at least one fitted cap which is worn on a finger of the human operator, whereas the fitted cap is equipped with 3D feeling sensors. Thereby, when the 3D feeling sensors are in contact with a surface of an object or materials, the 3D feeling sensors provide 3D information regarding the contact made by the sensors with the surface to the processing unit. The feeling sensors and multiple sensors map the interaction between the human operator and material with which the operator manipulates, thereby obtaining the material behaviour by identifying the forces applied to the material and identifying the displacement of the material by the multiple sensors.

In embodiments of the present invention, the learning environment is part of a master-slave robotic concept, having a master expert machine (MEM) robot for learning and recording a professional task learnt from a human operator, wherein the processing unit is integrated into the MEM robot, so as to create within the MEM robot a sharable data base for computing a control law for the task required for a slave expert machine (SEM) robot. In this case, the learning environment further includes (e) one or more anthropomorphic palms, including three or more fingers, operatively attached to the arms of the MEM robot the human operator teaches the MEM robot the sequence of operations required to perform the task in the learning environment. Preferably, the anthropomorphic palm includes three fingers, wherein each of the fingers includes at least one 3D feeling sensor. Each of the fingers of the anthropomorphic palm has more degrees of freedom (DOFs) than a human finger, thereby enabling the finger to perform any task that a human finger is capable to perform.

An aspect of the present invention is to provide a method for transferring knowledge from a human operator to a mobile MEM robot, thereby teaching MEM robot to perform the required professional task so as to create within the MEM robot a sharable data base for computing a control law for the task required for a slave expert machine (SEM) robot. The method includes the following main sequence of steps: (a) providing one or more anthropomorphic palms operatively attached to the MEM robot; the anthropomorphic palm includes three or more fingers each of which include one or more 3D feeling sensors; (b) providing a learning environment, which includes multiple sensors and a processing unit; and (c) performing the professional task by the hands of the human operator within the learning environment. The at least one anthropomorphic palm is operatively attached to a palm of the human operator. The 3D feeling sensors and the multiple sensors provide continuous 3D data of the position, displacement, velocity and force sensed at each of the joints of the finger.

An aspect of the present invention is to provide an anthropomorphic palm including three or more fingers, wherein at least one of the fingers includes at least one 3D feeling sensor. Each of the fingers has more degrees of freedom (DOFs) than a human finger, thereby enabling the anthropomorphic palm to perform any task that a human is capable to perform. Preferably, the anthropomorphic palm includes three fingers.

In embodiments of the present invention, the 3D feeling sensors are integrated into the control loop of a robotic system, thereby substantially improve the operational sensitivity of the robot.

### BRIEF DESCRIPTION OF THE DRAWINGS

The present invention will become fully understood from the detailed description given herein below and the accompanying drawings, which are given by way of illustration and example only and thus not limitative of the present invention.

FIG. 1 (Prior art) illustrates a welding robot which is a present state of the art in robotic technology;

FIG. 2 (Prior art) illustrates a task of tying the laces of a shoe, that is beyond prior art robot's capability;

FIG. 3 schematically illustrates the Master-Slave robotic concept, showing an example task of fruit cutting, whereas the master robot learns the task from a skilled worker in the learning environment and the slave robot performs the task independently;

FIG. 3a shows a perspective view of the human palm holding the 3-Fingers improved Anthropomorphic Palm, shown in FIG. 3;

FIG. 4 schematically illustrates a human hand “wearing” three dimensional (3D) feeling sensors, attached to his thumb and additional two fingers, according to embodiments of the present invention;

FIG. 5 schematically illustrates an improved anthropomorphic 3 fingers gripper, according to embodiments of the present invention;

FIG. 6 illustrates an example learning environment, according to embodiments of the present invention;

FIG. 7 exemplified an analysis of a learning environment, an example of which is shown in FIG. 6;

FIG. 8 illustrates an example of an improved tele-robotic, according to embodiments of the present invention; and

FIG. 9 illustrates an example embodiment of the learning environment of the present invention, where a skilled worker transfers the task performing knowledge to a shareable data base via a set of gloves equipped with 3D feeling sensors.

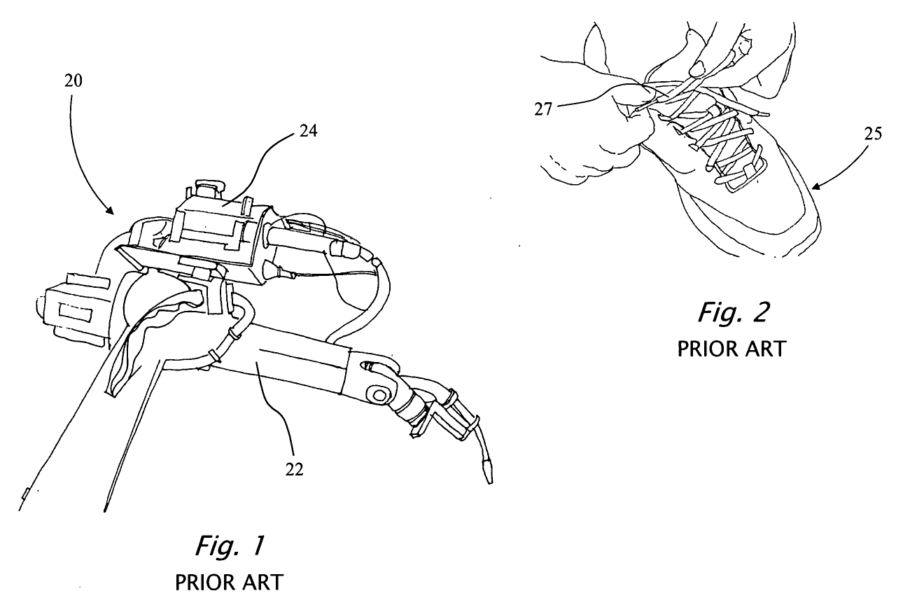

### DETAILED DESCRIPTION OF THE INVENTION

It is the intention of the present invention to provide a learning environment and method which is a first milestone in an expert machine that implements the master-slave robotic concept. The present invention is of a learning environment and method for teaching the master expert machine (MEM) by a skilled worker that transfers his professional knowledge to the master expert machine in the form of elementary motions and subdivided tasks.

It is a further intention of the present invention to provide a stand alone learning environment, where a human wearing one or two innovative gloves transfers a task performing knowledge to a robot in a different learning process than the Master-Slave learning concept. The glove's fingers are equipped with 3D feeling sensors and the displacement, velocity\acceleration and force are recorded. A computerized processing unit and records and prepare the acquired data for a mathematical transformation which result is commands to the motors of a slave expert machine (SEM) robot, or in other words, the processing unit calculates the next trajectory to be performed by of the robot.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

The complexity of the human mechanism leads to a specific learning process where a machine learns know how of a professional task from a professional skilled worker. The process includes the construction of a novel system consisting of one or more improved anthropomorphic 3 fingers gripper, 3D feeling sensors and a provided learning environment.

Typically, the three finger improved anthropomorphic palm could be connected to a 6 degrees-of-freedom (DOF) robotic arm, equipped with 3D feeling sensors, and obtaining the human's knowledge in an innovative learning environment. The incorporating of 3D feeling sensors into a robotic system significantly enhances the sensitivity of the performed process, such as interaction with various objects. Tracking and recording three dimensions of displacement and three dimensions of the acting forces is the mission of the learning environment.

### The Machine Learning Concept and Applications

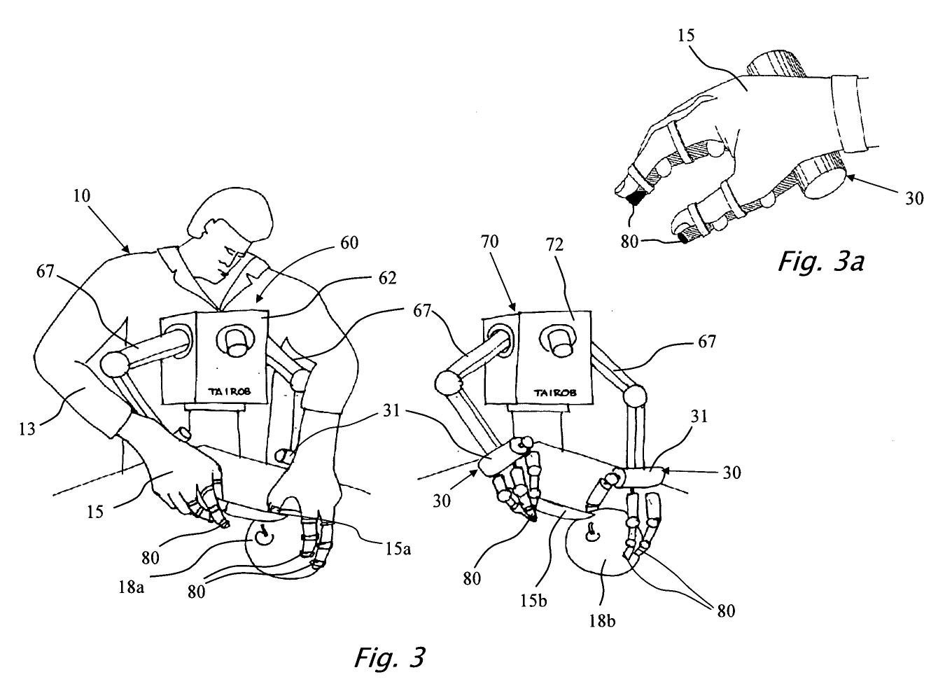

Reference is made to the drawings. FIG. 3 schematically illustrates the Master-Slave robotic concept, showing an example task of fruit cutting, whereas master robot 60 learns a task from a skilled worker 10 in the learning environment and slave robot 70 performs the task independently. FIG. 3a shows a perspective view of human palm 15 holding 3-Fingers improved anthropomorphic palm 30.

The improved anthropomorphic palms 30, is connected, for example, to six degrees-of-freedom robotic arms\manipulators 67. Palms 30 are equipped with 3D feeling sensors 80, and obtain the human's knowledge in the learning environment in by master robot 60.

The teaching of master robot 60 is performed by dynamic tracking the activity of hands 13 of a skilled human operator 10. Skilled human operator 10 holds palms 30 of master robot 60, while performing together the physical activity, for example, holding knife 15a and slicing apple 18a. The dynamic transfer of the sequence of the mechanical moves from skilled human 10 is learnt or copied by master robot 60 since palms 30 of master robot 60 consists of 12 DOF, a higher number than a human's palm, a fact that will enhance the performance of robotic palm 30 relative to the humans palm.

The tracking activity is performed in the learning environment where the human operator divides the task into sub-tasks that are taught one at a time. A specific sub-task is transferred to the master robot by moving spatially along the corresponding trajectory, or a set of elementary trajectories, corresponding to the task. Skilled worker 10 teaches master robot 60 by holding and carrying palm 30, along a predefined trajectory in the learning environment to perform the task. Master robot 60 records the motion and forces associated with material handling, grasping or human\machine interaction for a later stage, where the recorded data is fabricated and transmitted to slave robot 70.

The sensors connected to palms 30 generate signals in response to the movements of hands 13 of skilled human 10. The performance—i.e. position, acceleration, “feelings” and applied joint forces are saved. The signals are converted into digital form and stored in the sharable data base.

Palm 15 of skilled human operator 10 may also wear an arrangement 40 including fitted caps that are worn on the finger and equipped with 3D feeling sensors 80, displacement, acceleration and force sensors (not shown) for other scientific and engineering options, such as, direct recording of the human's movement for a replication mission and\or for improving the human's task performance due to a superior degrees of freedom of the robot's palm 30 relative to the humans palm 15. 3D feeling sensors 80 provide 3D information regarding the contact of sensors 80 with a surface of an object or materials, such as friction, perpendicular force variation, tangential force variation and tactile roughness. Wires 42 are connected to a connection band 43 and further connected by wire 44 to transfer to the data acquisition system. The stress\force\friction signals are then recorded and correlated to the known texture of the material\friction\roughness.

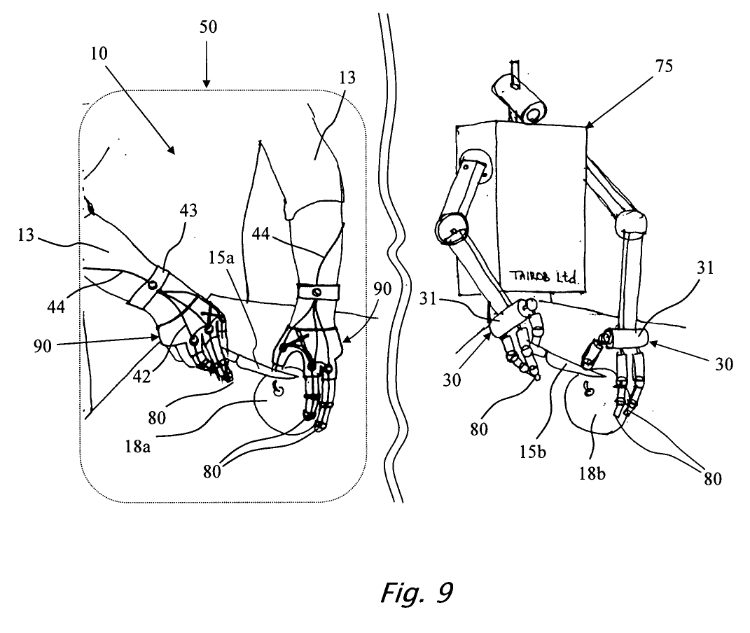

Reference is made to FIG. 9, which illustrates an example embodiment of learning environment 50, according to embodiments of the present invention. Skilled worker 10 transfers the task performing knowledge to a shareable data base via a set of gloves 90 equipped with 3D feeling sensors 80. The recorded knowledge is than transformed by the processing unit into a robot's task performance and transmitted to robot 75. In this case, the teaching is performed by tracking the activity of a human hand 13 that wears a special glove 90 equipped with various sensors. The human operator's physical activity is tracked in learning environment 50 where human operator 10 performs a specific task. The sensors connected to glove 90 generate signals in response to the movements of hand 13. The signals are converted into digital form by a computerized processing unit, that stores in the sharable data base and prepare the acquired data for a mathematical transformation which result is commands to the motors of robot 75, or in other words, the processing unit calculates the next trajectory of robot 75.

The learning process, as shown to FIG. 3, is followed by a mathematical process leading to the “minimum sensory” calculations\concept so as to prepare the fabricated data to be transferred to slave robot 70, an expert machine (according to U.S. Pat. No. 6,272,396). The expert performance will be the average of many trials at the plateau of the learning curve.

The present invention extends robotic systems engineering methods by allowing the performance of sensitive related tasks, deals with open-ended and frequently changing real-world environments via its learning process. It develops the capability to respond to unsolved gaps in the response of present robotic systems knowledge and behaviour.

The present invention intends to extend systems engineering methods to develop system capabilities to respond to situations or contexts that are a complicated compound of elementary activities. The new system design, engineering principles and implementations for machines or robots will be versatile to deal with real tasks and to interact with people in everyday situations.

The new technology is intended for autonomous surveillance systems, artificial cognitive systems and intelligent robots that replace the capabilities of people to perform routine, dangerous or tiring tasks. It opens new horizons and breakthroughs in advanced behaviours of robots, such as in manipulating objects and interacting socially, which are main goal to assist an elder person.

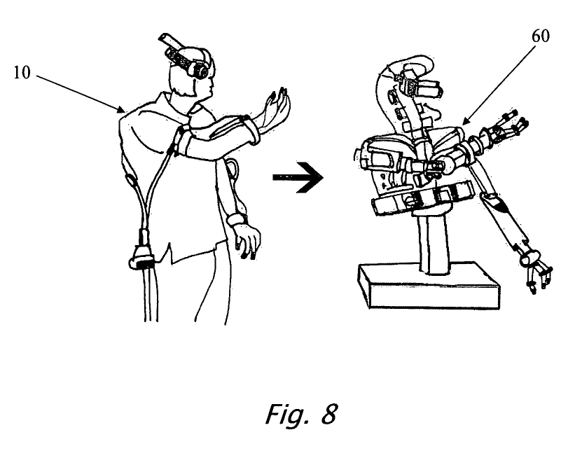

The present invention leads to a robotic system that is independent, without the need for external re-programming, re-configuring, or re-adjusting. Performance requirements will be delivered prior to start of task. The new robotic systems can co-operate with the operator based on its knowledge acquired during a special learning process, performed in the laboratory prior to arriving to the working area. The knowledge is based on a well grounded understanding of the objects, events and processes in the working environment so as to transform the robotic system into an independent assembly line worker after it received the appropriate performance instructions from its human operator/supervisor. Work will result in demonstrators that operate largely autonomously in demanding and open-ended environments which call for suitable high performance capabilities for sensing, data analysis, processing, control, communication and interaction with human operators or with other robotic systems. An improved tele-robotic, can be achieved by using the learning system and method of the present invention, as exemplified in FIG. 8.

### The Concept in Details

The process of transferring knowledge from skilled worker 10 to a data base (to be fabricated for an expert machine) includes the following three components that form one unit for adapting the knowledge:

(a) A learning environment;

(b) A 3D feeling sensor (related to friction, force and tactile roughness); and

(c) A robotic improved three finger anthropomorphic palm.

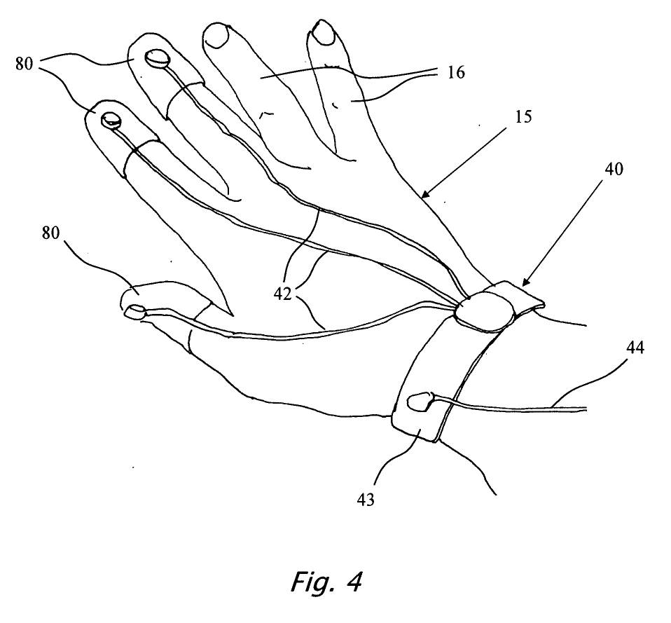

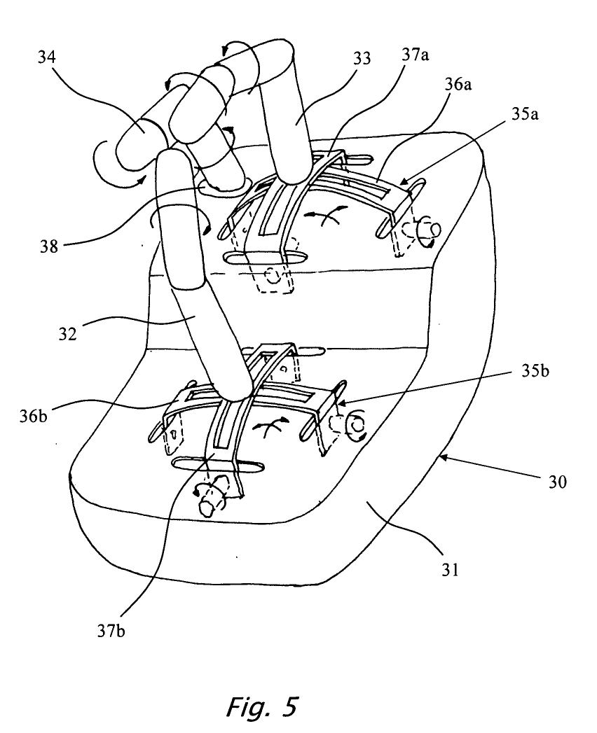

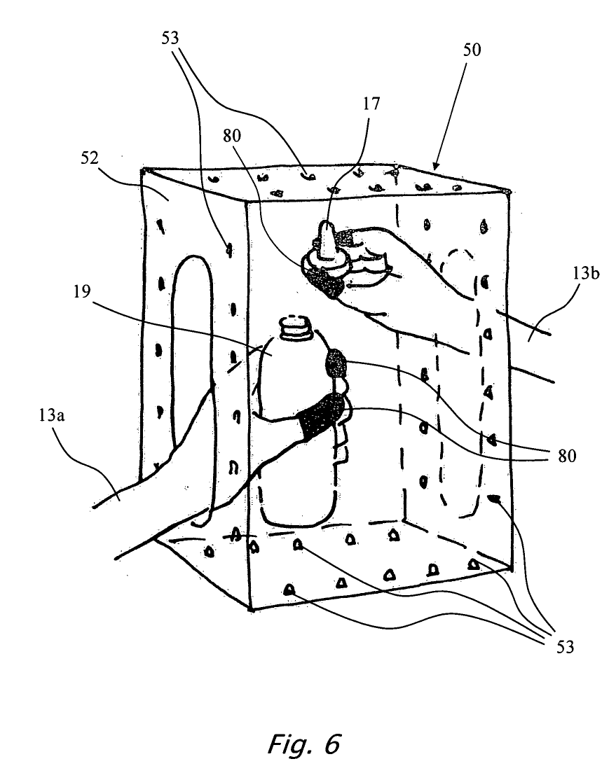

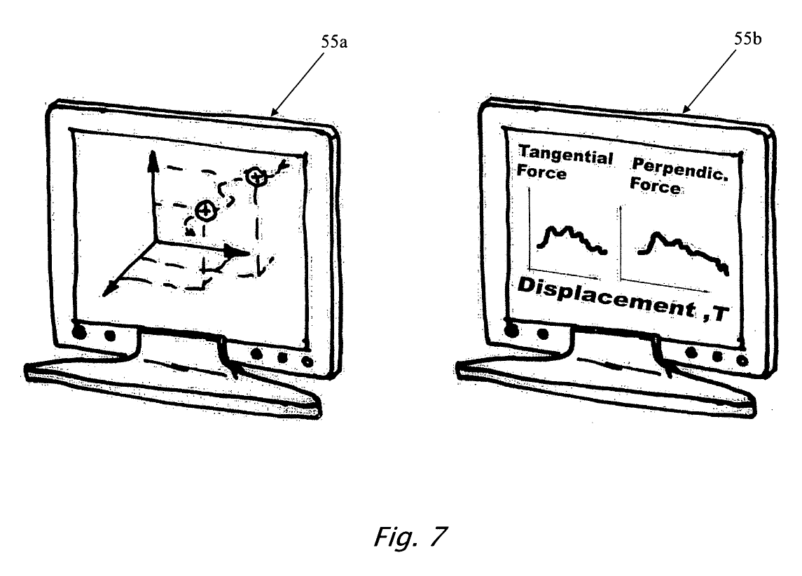

FIG. 4 schematically illustrates human palm 15 “wearing” the 3D feeling sensors 80, attached to his thumb and additional two fingers, according to embodiments of the present invention; FIG. 5 schematically illustrates an improved anthropomorphic 3 fingers gripper 30, according to embodiments of the present invention; and FIG. 6 illustrates an example learning environment 50, according to embodiments of the present invention, the analysis of which is exemplified in FIG. 7.

### The Learning Environment

Learning environment 50 includes an enclosed environment cell 52, multiple optical sensors and others such as, RF sensors 53 and a processing unit. Environment cell 52 set a restricted 3D space defining the learning environment space. Environment cell 52 is surrounded and equipped with optical sensors 53 and a set of video cameras (not shown) for the mapping of dynamic motion within the space that forms learning environment 50. For example, two human hands equipped with 3D feeling sensors 80, handling an object 17 in one hand and a coupling object 19, whereas 3D feeling sensor 80, is defined as a tactile combined force and moment sensor.

The relationship (force/friction/moment) between the human hands 13 and the objects (17, 19) is measured, and graphically displayed (according to the displacement and time pending) on a computer's screen 55. The measured data undergoes processing to form the data base for the process governing the robotic palm movements.

Learning environment 50 includes mechanical devices, video cameras, other optical, RF, and/or sonic sensors 53, 3D feeling sensors 80 and a synchronized, simultaneous data acquisition system. Hundreds of sensors 53 (for example, laser diodes, RF transmitters, light sources, etc.) transferring data simultaneously, transfer the data to a data acquisition system that is able to capture that amount of channels while being synchronized with the data acquired by the cameras. Some optical sensors 53 are assembled as pairs of a transmitter and receiver on opposite walls of learning environment cell 52 (two sets for four walls). In this case, the physical location of sensors 53 provides the sensitivity of the displacement achieved within learning environment 50. RF transmitters (not shown) can be located, for example, at appropriate corners of learning cell 52. Optical sensors 53 can be located within an array where four sensors (twice transmitter and receivers) on two sets of opposite walls will define a physical point.

Optionally, another light source (not shown) can cast a shadow on the opposite side of cell 52, which can be decoded to allocate the hand\material. The assembly of sensors within learning environment 50 is accompanied by a calibration process.

The complexity of the video cameras software would include side-by-side views, (like, the left-TV view 55a on the screen's right and the right-TV view 55b on the screen's left), two images of the hand/material simultaneously mapping the displacement of objects and sensors location relative to the material. The material behaviour would be extracted by identifying the displacement of the material.

The force parameters are supplied by 3D feeling sensors 80. Relating the “feeling” parameters to 3D displacement within teaching environment 50, paves the way to record, qualify, quantify and identify a particular move or manoeuvre and understand the process of the human/machine interaction.

A potential problem might arise while the object or a part of it is hiding behind the palm, thus not being seen either by the video cameras or by the optical sensors. Reconstruction algorithms such as pattern recognition identify the “missing” parts.

The dynamic tracking algorithm of the human/material (machine) interaction via a set of video cameras, intend to detect the palm/fingers interaction with the objects. The video cameras capture the 3D position of the user's hand at a known rate. The tracking position is accompanied by optical sensors 53 and related to 3D feeling sensors 80.

The output of the learning environment 50 is the relation between the adapted force and the finger or object's reaction, i.e. a specific force at an arbitrary point causes a specific pressure or deformation that is “seen” by the video cameras or optical sensors 53.

### 3D Feeling Sensor (Related to Friction, Tangential Force Variation and Tactile Roughness)

Referring back to FIGS. 3 and 4, robot gripper 30 or human hand 13 are incorporated with 3D feeling sensors 80, that move along the surface of a handled object while causing a time varying limited pressure (acting on the handled object) perpendicular to the surface. The sensors sense measurable perpendicular forces to the surface adjacent to the working piece, as well as tangential forces/torque.

3D feeling sensor 80 allows simultaneously local measure of the sense of motion (3D displacement—where a variable predetermined pressure acts on sensor 80) and the sense of touch by generating appropriate electrical signals. The sensor (80) is integrated into body 31 of anthropomorphic palms 30 or into the flexible envelope sensing glove 90, wherefrom wires 92 are connected to a connection band 93 and further connected by wire 94 to transfer to the data acquisition system. The stress\force\friction signals are then recorded and correlated to the known texture of the material\friction\roughness.

### Smart Materials and Sensor Structure

In the preferred embodiments of the present invention, 3D feeling sensor 80 is based, for example, on piezoelectric materials, for example, a Barium Titanite mono-crystal layer that could be of improved electrical response. It should be noted that the present invention is not limited to 3D feeling sensors 80 made on piezoelectric materials and any type of 3D feeling sensor can be used by the present invention, including sensors under development such as miniature 3D MEMS (micro-electro-mechanical system) sensors or fibber-optics Bragg based technology sensors. The type of 3D sensor does not affect the learning concept developed in this application.

Tactile sensing for robotic hands is essential in order to grip and manipulate objects in different ways. Different issues have to be contemplated when developing a sensor system for a robotic hand: on the one side the sensor system has to fit inside the hardware of hand while maintaining a high spatial resolution. At the other side the number of cables coming from the sensor cells should be small in order not to hamper the flexibility of the hand. On the finger tips sensor arrays with a very high spatial resolution are desired for controlling objects when manipulating them with a precision grasp, whereas within the palm the resolution does not have to be as fine as on the finger tips. For precise grasping of objects with anthropomorphic robotic hands, a tactile feedback is mandatory. It enables an inference on geometry and character of a grasped object and therefore supports secure handling.

### Anthropomorphic 3 Fingers Palm 30

Referring back to FIG. 5, “Human like” activities for performing professional jobs and the complexity of the human mechanism preferably lead to a complicated construction of a 3 finger gripper 30 consisting of a palm body 31, thumb 32 being a finger at a relative different level than others two fingers (33, 34). The fingers (32, 33, 34) include of miniature motors, transmission and sensors components.

Existing grippers “suffer” from lack of sensitivity, damping and force response. Gripper 30 of the present invention is equipped with displacement, acceleration and moment sensors, disposed on each motor's axis and prepared to “wear” described 3D feeling sensors 80. 3D feeling sensors 80 are embedded on every finger (32, 33, 34) in order to achieve good material sensitivity performance.

Preferably, end effectors (gripper) 30 includes of a total of 12 DOFs incorporated into 3 fingers: thumb 32, finger 33 and assisting finger 34. Typically, the dimensions of the fingers (32, 33, 34) are generally similar to corresponding human fingers (in particular, the width and length dimensions). It should be noted that the dimensions of the fingers (32, 33, 34) are not limited to correspond to the dimensions of human fingers and can be of any size and shape.

Typically, end effector 30 is constructed from light weight materials, where sharp shaped edges or surfaces are prevented. No bold obstacles along the finger (keeping the anthropomorphic shape) for continuous operations and preventing fabric's inconsistency during material handling.

In embodiments of the present invention, the fingers (32, 33, 34) are equipped with (not shown) miniature/micro motors, rotary encoders and velocity reduction gearbox where needed. Mechanically assembly of miniature components and micro-mechanical transmission means are accompanied by electronics and computerized control means.

Force/moment 3D sensors 80 are preferably disposed at all of the fingers (32, 33, 34). Displacement and acceleration sensors are adapted to the axis, housing or joint yielding a kinematics model of the movement of gripper 30.

The present development\patent overcomes the damping, force and sensitivity limits of the existing grippers and robotic arms by using the new learning and control strategy.

### Impact

The combination of an improved anthropomorphic palm 30 equipped with the three dimensional 3D feeling sensors 80 interacting with materials within learning environment 50, creates a new technology that allows robotic independent execution of tasks that have never been achieved before. The learning from a skilled human minimizes task performance uncertainty and paves the way to a robot with “human-like” tactile sensitivity, a robot that does not currently exist and can be considered a break-thru in the current state-of-the-art.

We assume that there exists some uncertainty to prove that a human's specific move is superior to a machine's performance. Therefore, the aim of the proposed patent is to perform a better (or more effective) human's activity. For this reason, 3-finger palm 30 preferably has more degrees of freedom (the upper part of the finger could rotate) than a human's hand. This strategy ensures that at the learning stage, the robot records the human's move via the appropriate sensors, so as to record a whole task by elementary moves. Later, at the SEM robotic task performance stage, the human's activity could be improved by appropriate mathematical transformations and control laws.

Learning from a skilled human worker could save many software programming hours (calculated as person years of work), causing a significant reduction in labour cost. Incorporating the learning capability into a robot yields a task performance without the need for additional tooling or installation, external re-programming, re-configuring or re-adjusting procedures. The implementation of these tasks will allow the co-operation between Man/Machine and Machine/Material interaction via the learning process using the 3D feeling sensors that will become an integral part of the control system as provided by U.S. Pat. No. 6,272,396. The 3D feeling sensors, in collaboration with the learning system, will allow the handling of tangible objects of different sizes and shapes, handling or avoidance of obstacles, processing material or serving the ageing population.

An example application of the technology of the present invention is a robot that operates a sewing machine in the Apparel Industry. Additional robots will replace other human workers along the assembly line of apparel.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

What is claimed is:

1. A learning environment for learning task performing knowledge from a human operator, the learning environment comprising:
(a) a cell body defining an restricted learning environment space;
(b) one or more 3D feeling sensors;
(c) multiple sensors for sensing the presence and motion of an object inside said learning environment space; and
(d) a processing unit,
wherein said human operator performs said task inside said learning environment space;
wherein said 3D feeling sensors provide 3D information regarding the contact of said sensors with a surface of an object or materials, wherein said 3D information is selected from a group including friction, perpendicular force variation, tangential force variation and tactile roughness;
wherein said multiple sensors sense the 3D location, displacement, acceleration and forces of an object inside said learning environment space; and
wherein said processing unit analyzes and records the data transmitted by said 3D feeling and multiple sensors and by said optical sensors.

2. The learning environment of claim 1, wherein said multiple sensors are selected from a group including: optical sensors, video cameras, acceleration sensors, RF sensors, sonic sensors and other sensors.

3. The learning environment of claim 1, wherein one or more of said multiple sensors are video cameras configured to acquire a plurality of images of the environment enclosed in said learning environment.

4. The learning environment of claim 1, wherein said finger of said 3D feeling sensors are made of piezoelectric materials.

5. The learning environment of claim 1, wherein said human operator wears an arrangement or a glove comprising at least one fitted cap, wherein said fitted cap is worn on a finger of said human operator and said fitted cap is equipped with said 3D feeling sensors, thereby, when said 3D feeling sensors are in contact with said surface of said object or materials, said 3D feeling sensors provide 3D information regarding the contact of said sensors with a surface of said object or materials to said processing unit.

6. The learning environment of claim 1, wherein said 3D feeling sensors and said multiple sensors map the interaction between said human operator and said material, thereby obtaining said material behaviour by identifying the forces applied to said material and identifying the displacement of the material by said multiple sensors.

7. The learning environment of claim 1, being part of a master-slave robotic concept, having a master expert machine (MEM) robot for learning and recording a professional task learnt from a human operator, wherein said processing unit is integrated into said MEM robot, so as to create within said MEM robot a sharable data base for computing a control law for the task required for a slave expert machine (SEM) robot, the learning environment further comprising:
(e) one or more anthropomorphic palms, comprising three or more fingers, operatively attached to the arms of said MEM robot,
wherein said human operator teaches said MEM robot the sequence of operations required to perform said task in said learning environment.

8. The learning environment of claim 7, wherein said anthropomorphic palm comprises three fingers.

9. The learning environment of claim 7, wherein each of said fingers comprises at least one of said 3D feeling sensors.

10. The learning environment of claim 7, wherein each of said fingers of said anthropomorphic palm has more degrees of freedom (DOFs) than a human finger, thereby enabling said finger of said anthropomorphic palm to perform any task that a human finger is capable to perform.

11. A method for transferring knowledge from a human operator to a mobile MEM robot, thereby teaching MEM robot to perform the required professional task so as to create within the MEM robot a sharable data base for computing a control law for the task required for a slave expert machine (SEM) robot, the method comprising the following main sequence of steps:
(a) providing one or more anthropomorphic palms, comprising three or more fingers, operatively attached to said MEM robot wherein said fingers of said anthropomorphic palms include 3D feeling sensors; and
(b) providing a learning environment, wherein said learning environment includes multiple sensors and a processing unit; and
(c) performing said professional task by the hands of said human operator in said learning environment, wherein said at least one anthropomorphic palm is operatively attached to a palm of said human operator and wherein said 3D feeling sensors and said multiple sensors provide continuous 3D data of the position, displacement, velocity and force sensed at each of the joints of said finger.

12. The method of claim 11, wherein said multiple sensors are selected from a group including: optical sensors, video cameras, acceleration sensors, RF sensors, sonic sensors and other sensors.

13. The method of claim 11, wherein one or more of said multiple sensors are video cameras configured to acquire a plurality of images of the environment enclosed in said learning environment.

14. An anthropomorphic palm comprising three or more fingers, wherein at least one of said fingers comprises at least one 3D feeling sensor.

15. The anthropomorphic palm of claim 14, wherein each of said fingers of said anthropomorphic palm has more degrees of freedom (DOFs) than a human finger, thereby enabling said finger of said anthropomorphic palm to perform any task that a human finger is capable to perform.

16. The anthropomorphic palm of claim 14, wherein said anthropomorphic palm, comprises three fingers.

17. The anthropomorphic palm of claim 14, wherein said 3D feeling sensors are integrated into the control loop of a robotic system, thereby substantially improve the operational sensitivity of the robot.
